(19) United States
(12) Patent Application Publication
(10) Pub. No.: US 2013/0170452 A1
(43) Pub. Date: Jul. 4, 2013

(54) Low Complexity Beamforming Scheme

(71) Applicant: FUTUREWEI TECHNOLOGIES, INC., Plano, TX (US)

(72) Inventor: Young Hoon Kwon, San Diego, CA (US)

(73) Assignee: FUTUREWEI TECHNOLOGIES, INC., Plano, TX (US)

(21) Appl. No.: 13/732,038

(22) Filed: Dec. 31, 2012

Related U.S. Application Data
(60) Provisional application No. 61/583,044, filed on Jan. 4, 2012.

(51) Int. Cl. H04W 72/04

(52) U.S. Cl. CPC H04W 72/04
USPC 370/329

(57) ABSTRACT

Beamforming can be simplified by selecting beamforming parameters without relying on channel state information (CSI). More specifically, beamforming parameters may be selected without CSI by applying different beamforming weight vectors to different subcarriers of a reference packet, and thereafter identifying which subcarrier had the highest signal quality upon reception of the reference packet by the user equipment (UE). The reference packet may be any packet, including a beacon packet, a null data packet, and other packets that are communicated periodically by an access point (AP). One or multiple codebooks may be used, and different codewords (or sets of codewords) may be applied in a time division multiplying (TDM) fashion.

This application claims the benefit of U.S. Provisional Application No. 61/583,044, filed on Jan. 4, 2012, entitled “Low Complexity Beamforming Scheme,” which is hereby incorporated herein by reference as if reproduced in its entirety.

### TECHNICAL FIELD

The present invention relates generally to communications methods and systems, and, in particular embodiments, to a method and system for low complexity beamforming in a wireless network.

### BACKGROUND

Beamforming is a signal transmission technique that exploits constructive interference in order to achieve spatial selectivity, and is performed by transmitting a signal over multiple antennas in accordance with a beamforming weight matrix (BF weight matrix) to produce a pattern of constructive and destructive interference in the wavefront. The BF weight matrix manipulates the phase and amplitude of each antenna element in order to maximize signal strength at the receiver's position. Accordingly, careful selection of the BF weight matrix is crucial to ensure satisfactory beamforming performance.

Conventionally, the BF weight matrix is selected in accordance with channel state information (CSI), which may be obtained through explicit or implicit feedback techniques. However, receiver side processing associated with explicit/implicit feedback may result in high levels of power consumption and/or require complex baseband processing capabilities. For instance, when obtaining CSI via implicit feedback, the receiver may perform frequent sounding packet transmission and/or periodic calibration procedures to allow CSI for the forward CSI to be accurately inferred by the transmitter. Likewise, receivers that obtain CSI via explicit feedback may need to perform relatively complex baseband processing operations to perform channel estimation and/or compute the BF weight matrix. Accordingly, conventional techniques for BF weight matrix selection may prove problematic for receivers that rely on battery power or are incapable of complex baseband processing, e.g., battery operated sensors, etc. As such, less complex techniques for selecting the BF weight matrix are desired.

### SUMMARY

Technical advantages are generally achieved, by embodiments of this disclosure which describe methods and systems for low complexity beamforming in a wireless network.

In accordance with an embodiment, a method for selecting beamforming parameters by a transmitter is provided. In this example, the method includes communicating a reference packet over a plurality of sub-carriers, where a plurality of beamforming weight vectors are applied to the reference packet such that different beamforming weight vectors are applied to different sub-carriers. An apparatus for performing this method is also provided.

In accordance with another embodiment, a method for selecting beamforming parameters by a receiver is provided. In this example, the method includes receiving, by a station (STA), a reference packet from a transmitter, wherein the reference packet is received over a plurality of sub-carriers, and where the transmitter applies different beamforming weight vectors to different ones of the plurality of sub-carriers when transmitting the reference packet. An apparatus for performing this method is also provided.

### BRIEF DESCRIPTION OF THE DRAWINGS

For a more complete understanding of the present disclosure, and the advantages thereof, reference is now made to the following descriptions taken in conjunction with the accompanying drawing, in which:

FIG. 1 illustrates a diagram of a communications network;

FIG. 2 illustrates a diagram of an embodiment communications network;

FIG. 3 illustrates a flowchart of an embodiment method for operating a transmitter;

FIG. 4 illustrates a flowchart of an embodiment method for operating a receiver;

FIG. 5 illustrates a diagram of an embodiment reference frame;

FIG. 6 illustrates a diagram of another embodiment reference frame;

FIG. 7 illustrates a diagram of another embodiment communications network;

FIG. 8 illustrates a diagram of embodiment feedback indexes provided by a receiver;

FIG. 9 illustrates a diagram of an embodiment communications sequence;

FIG. 10 illustrates a table of assumptions used in simulations;

FIG. 11 illustrates a graph of simulation results obtained in accordance with aspects of this disclosure;

FIG. 12 illustrates another graph of simulation results obtained in accordance with aspects of this disclosure;

FIG. 13 illustrates yet another graph of simulation results obtained in accordance with aspects of this disclosure;

FIG. 14 illustrates yet another graph of simulation results obtained in accordance with aspects of this disclosure;

FIG. 15 illustrates yet another graph of simulation results obtained in accordance with aspects of this disclosure;

FIG. 16 illustrates a block diagram of an embodiment communications device; and

FIG. 17 illustrates a diagram of an embodiment computing platform.

### DETAILED DESCRIPTION OF ILLUSTRATIVE EMBODIMENTS

The making and using of embodiments of this disclosure are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

Disclosed herein are techniques for selecting BF weight matrixes without using CSI. In an embodiment, a transmitter applies different BF weight vectors to different sub-carriers of a reference packet, and then transmits/broadcasts the reference packet to one or more receivers. The receivers measure the signal quality of each sub-carrier upon receiving the reference packet, and feed back an index specifying the highest quality sub-carrier. The transmitter then uses the BF weight vector that was applied to the highest quality sub-carrier (as indicated by the index) to transmit data to the corresponding receiver over the plurality of subcarriers.

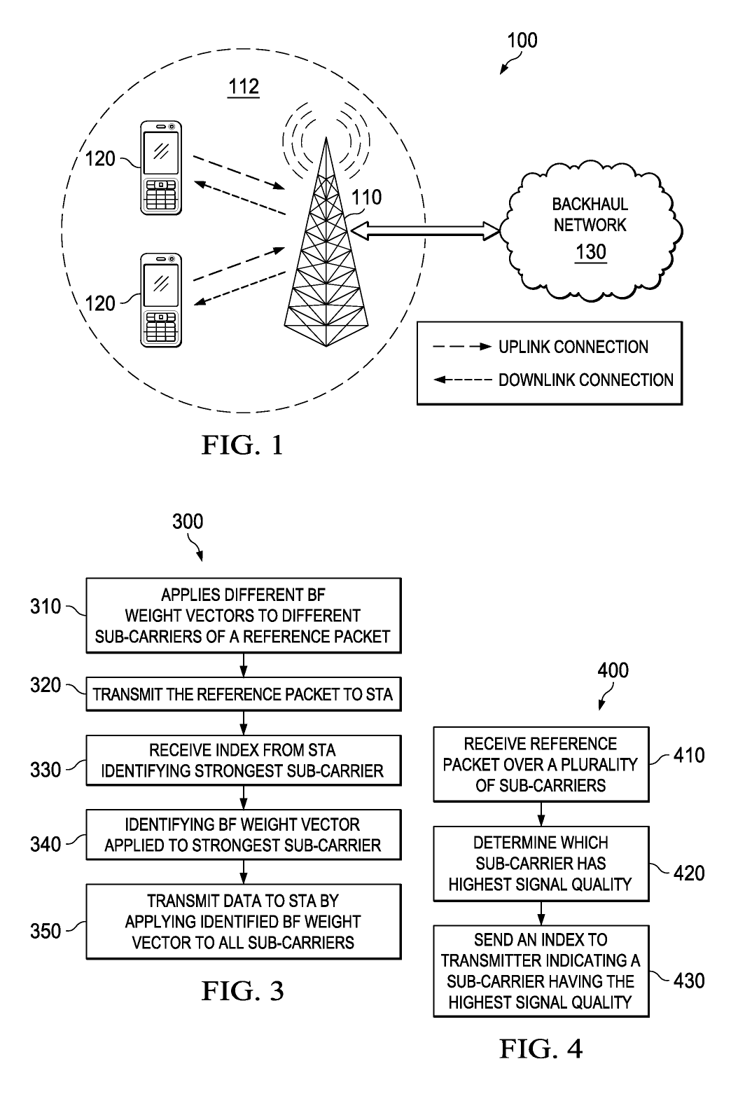

FIG. 1 illustrates a network 100 for communicating data. The network 100 comprises a transmit point (TP) 110 having a coverage area 112, a plurality of user equipments (UEs) 120, and a backhaul network 130. As discussed herein, the term transmit point (TP) may refer to any device used to transmit a wireless signal to another device, including a station (STA), a UE, a base station, an enhanced base station (eNB), a femtocell, etc. The TP 110 may be any component capable of providing wireless access to the UEs 120. The TP 110 may provide wireless access by, inter alia, establishing an uplink connection (dashed line) and/or a downlink connection (dotted line) with the UEs 120. The UEs 120 may be any component or collection of components that allow a user to establish a wireless connection for purposes of accessing a network, e.g., the backhaul network 130. The backhaul network 130 may be any component or collection of components that allow data to be exchanged between the TP 110 and a remote end (not shown). In some embodiments, the network 100 may comprise various other wireless devices, such as relays, femtocells, etc.

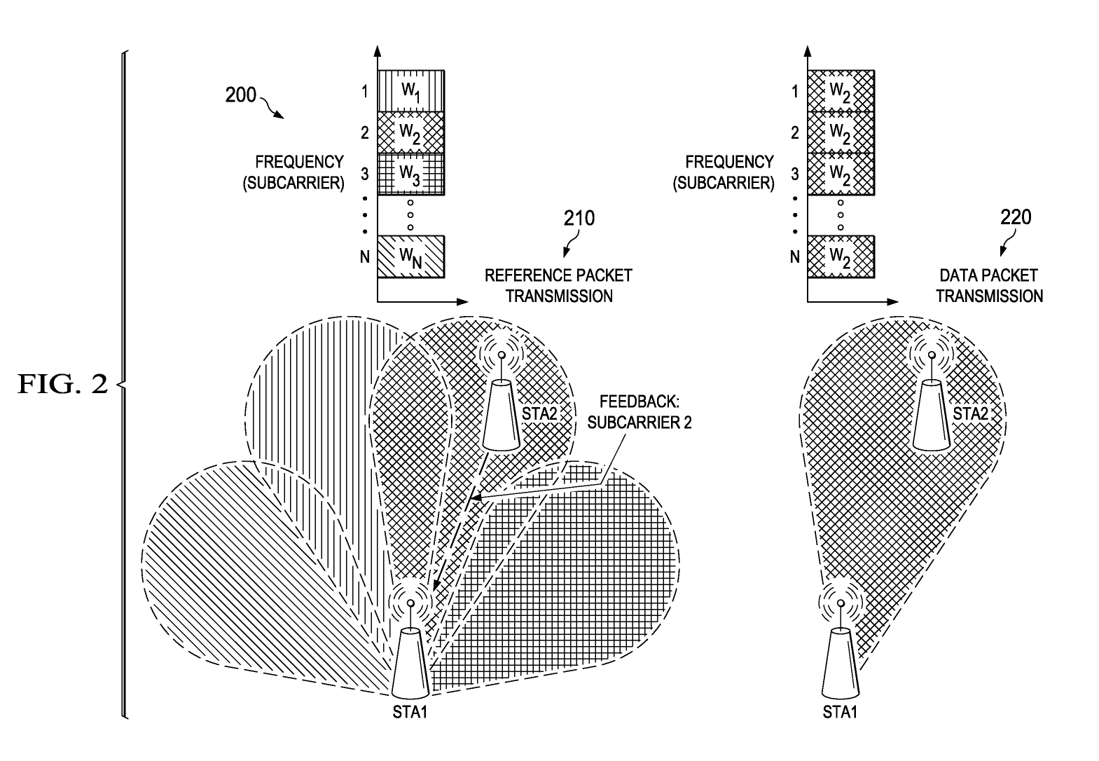

FIG. 2 illustrates a communications network 200 for selecting BF weight vectors in accordance with an embodiment of this disclosure. The communications network 200 comprises a first station (STA1) and as second station (STA2). The STA1 transmits a reference packet to the STA2 during a reference packet transmission 210. The STA1 transmits the reference packet over a plurality of sub-carrier frequencies (e.g., N sub-carrier frequencies), and applies different BF weight vectors (w₁˜w_{N}) to the subcarriers. Upon receiving the reference packet, the STA2 may determine which sub-carrier has the highest signal quality, and subsequently feed back a sub-carrier index of the highest quality subcarrier. In the example depicted in FIG. 2, the STA2 indicates that the second sub-carrier has the highest quality. Upon receiving the index, the STA1 determines that a second BF weight vector (w₂) was applied to the second sub-carrier during the reference packet transmission 210. Accordingly, the STA1 uses the second BF weight vector (w₂) to communicate data to the STA2 during a data packet transmission 220.

FIG. 3 illustrates a method 300 for operating a transmitter in accordance with an embodiment of this disclosure. The method 300 begins at step 310, where the transmitter applies different BF weight vectors to different sub-carriers of a reference packet. Next, the method 300 proceeds to step 320, where the transmitter transmits the reference packet to an STA. Thereafter, the method proceeds to step 330, where the transmitter receives an index from the STA identifying a strongest sub-carrier. Subsequently, the method proceeds to step 340, where the transmitter identifies the BF weight vector applied to strongest sub-carrier. Finally, the method proceeds to step 350, where the transmitter transmits data to the STA by applying the identified BF weight vector to all sub-carriers.

FIG. 4 illustrates a method 400 for operating a receiver in accordance with an embodiment of this disclosure. The method 400 begins at step 410, where the receiver receives a reference packet over a plurality of sub-carriers. Next, the method 400 proceeds to step 420, where the receiver determines which sub-carrier has highest signal quality. Finally, the method 400 proceeds to step 430, where the receiver sends an index to transmitter indicating the sub-carrier having the highest signal quality.

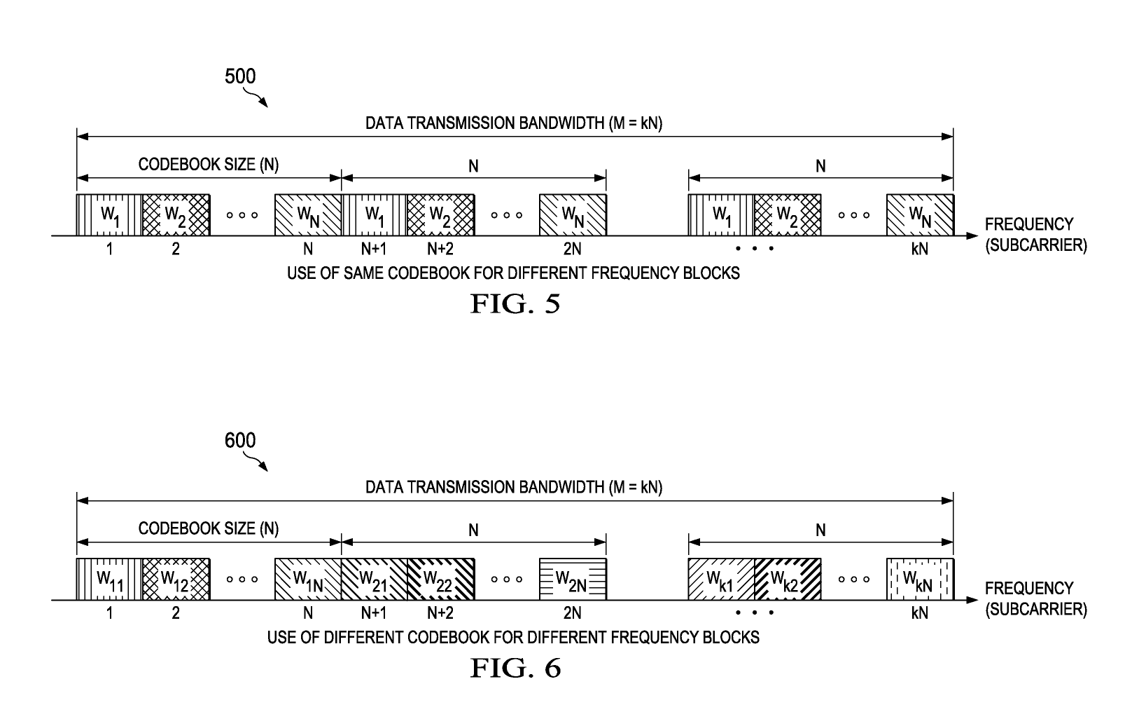

In some instances, the number of sub-carriers (N) in a channel may exceed the number of BF weight vectors in the codebook. In such instances, the sub-carriers (N) may be sub-divided into groups of consecutive sub-carriers, and the same or different codebooks may be applied to the groups of consecutive subcarriers. FIG. 5 illustrates a reference packet 500 in which a single codebook is re-applied to each group of sub-carriers. FIG. 6 illustrates a reference packet 600 in which different codebooks are applied to each group of consecutive sub-carriers. The codebooks applied to the reference packet 600 may be the same size, or may differ in size, and the transmitter may indicate the size of all codebooks to the receiver. In some embodiments, the receivers may not know the BF weight vectors applied to the various subcarriers, and may simply feed back an index identifying the sub-carrier having the highest signal quality.

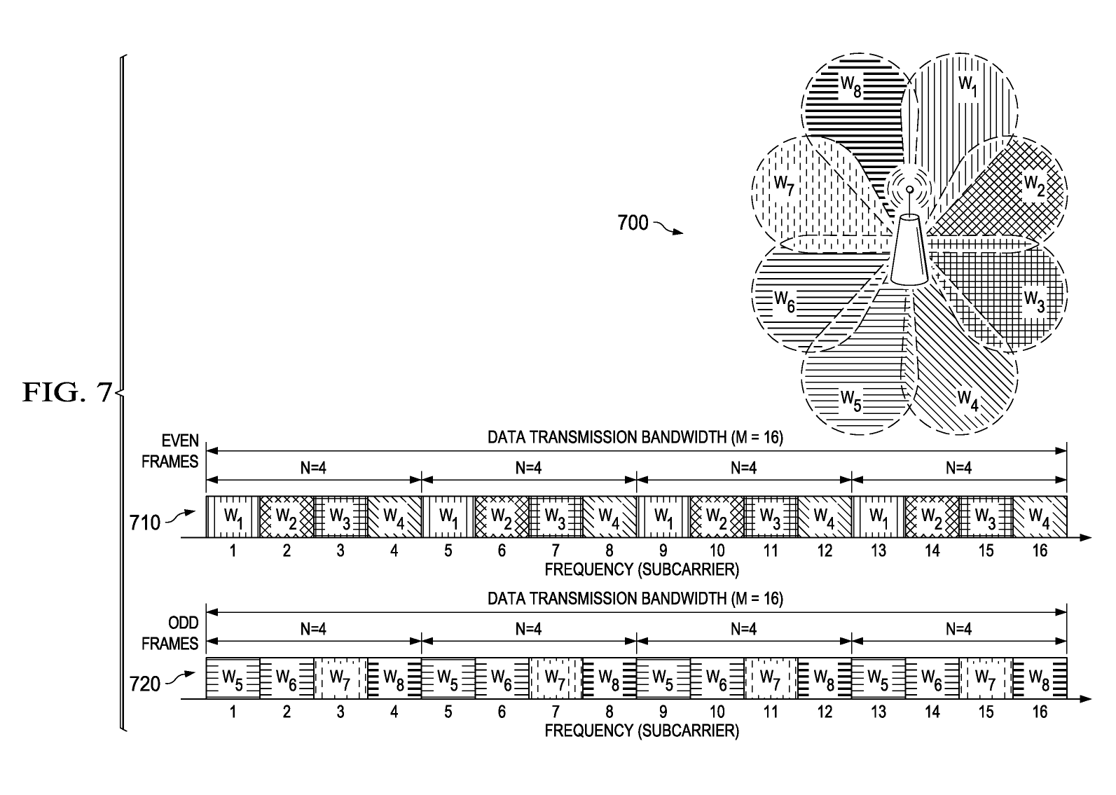

Different codebooks may also be applied over the same or different reference frames in a time division multiplexed (TDM) fashion. FIG. 7 illustrates a network 700 in which a first set of code words (w₁˜w₄) are applied to even reference frames 710, and a second set of codewords (w₅˜w₈) are applied to odd reference frames 720. As shown, the first set of code words (w₁˜w₄) may correspond to beamforms covering the right half of the coverage area, while the second set of code words (w₅˜w₈) may correspond to beamforms covering the left half of the coverage area. Hence, BF vectors within a given codebook have similar directional properties, thereby allowing groups of users to be served while other groups of users sleep. This may allow the users to reduce power consumption.

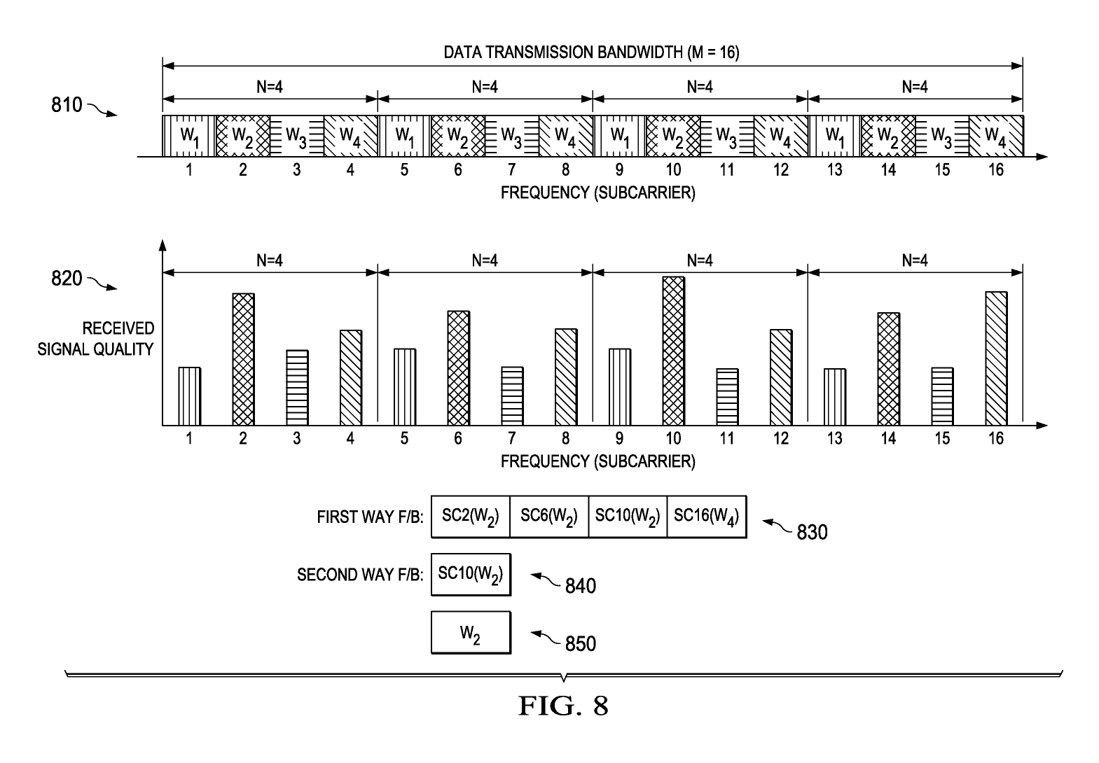

The index fed back by the STA may indicate one or more subcarriers. FIG. 8 illustrates how different sub-carriers within a reference packet 810 may have different signal qualities 820. In some embodiments, the receiver may feed back an index 830 that indicates a highest quality sub-carrier for each group of subcarrier. For instance, the index 830 may indicate that sub-carriers corresponding to a second codeword (w₂) had the highest signal quality for the first three groups of subcarriers, while a sub-carrier corresponding to a fourth codeword (w₄) had the highest signal quality for the fourth group of subcarriers. Alternatively, the receiver may feed back an index 840 that indicates a highest quality sub-carrier amongst all subcarriers. For instance, the index 840 indicates that a tenth sub-carrier (SC10) had the highest signal quality. Indicating the highest quality sub-carrier in each group of sub-carriers may achieve better performance in cases where the channel is not completely correlated (e.g., one BF vector cannot represent the channel characteristics of entire band), while indicating only the highest quality sub-carrier overall may reduce feedback related overhead. In yet other embodiments, the receiver may report back an index 850 that indicates the codeword that provides the highest average signal power. For instance, the receiver may combine the received signal quality of all sub-carriers using the same beamforming weight vector. For example, a received signal quality of a first sub-carrier (SC1), a fifth sub-carrier (SC5), a ninth sub-carrier (SC9), and a thirteenth sub-carrier (SC13) to obtain an average signal power for the first codeword (w₁). The receiver may also combine signal powers for sub-carriers corresponding to the second codeword (w₂), the third codeword (w₃), and the fourth codeword (w₄) to determine average signal powers for those codewords, and thereafter report the codeword that provides the highest average signal power to the transmitter. In this example, it will be the second codeword (w₂).

Reference packets may be any packets. In one embodiment, the reference packet may also be a null data packet (NDP). In other embodiments, the reference packet may carry control data that is unrelated to beamforming. For instance, when the transmitter is an access point (AP) or central station, the reference packet may be a control packet that is periodically transmitted by the AP or central station, such as a beacon packet that is periodically broadcast to multiple stations. Applying different BF vectors to sub-carriers in a broadcast reference packet may achieve greater frequency domain diversity. As such, using smaller codebooks may potentially improve reception performance. However, if codebook size is insufficient, then diversity may suffer. In such an instance, using different codebook for different frequency block effectively increases use of different BF vectors in different subcarriers, which can result in better broadcasting packet reception performance. When periodic beacons are used for a reference packet, using different BF vectors at different sub-carriers may randomize the BF pattern for different subcarriers, which may prevent unintended BF effect throughout the coverage. Some or all of the short training fields (STFs), long training fields (LTFs), signal fields (SIG), and data fields (DATA) may be beamformed in the same manner, which may not require additional fields (e.g., LTFs or otherwise). An independent sounding packet may also be used for reference packet.

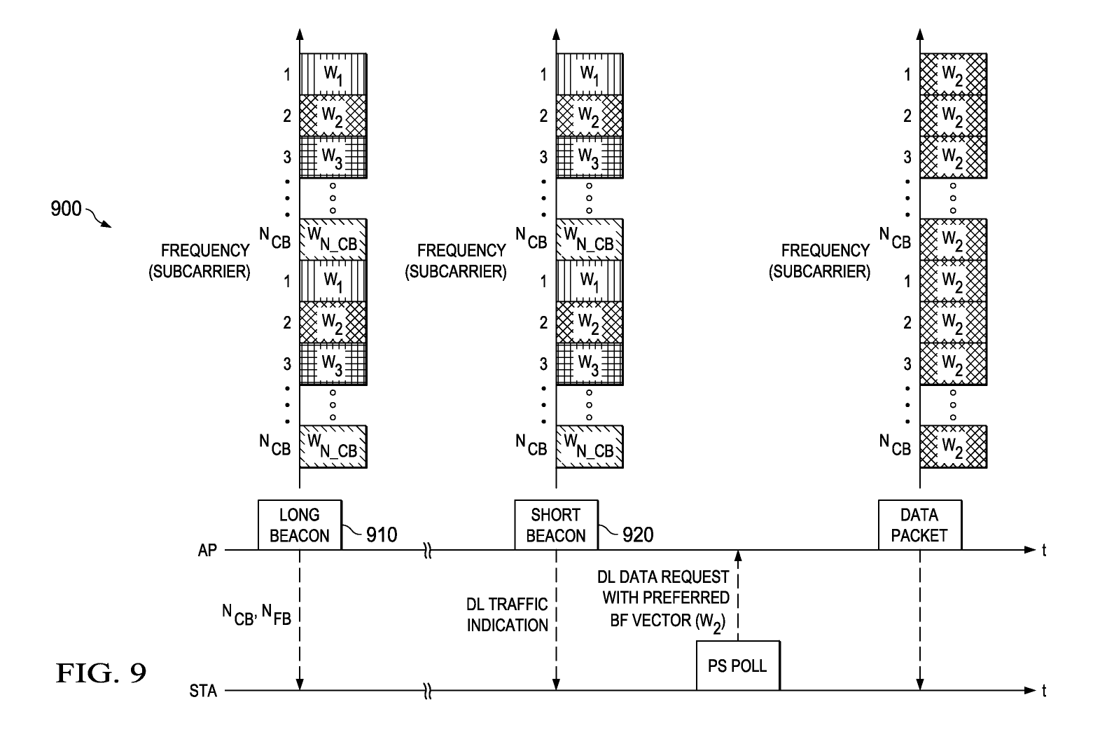

Feedback granularity can be flexible. FIG. 9 illustrates a protocol diagram 900 in which both a long beacon 910 and a short beacon 920 are used. Different beacons can be used for different feedback groups. For instance, the number of feedback groups (N_{FB}) can range between one and the ratio of the number of sub-carriers (N_{SD}) to the number of candidate beamforming vectors (N_{CB}) (i.e., between one and N_{SD}/N_{CB}). In case the number of sub-carriers (N_{SD}) is not a multiple of the number of candidate beamforming vectors (N_{CB}), the last group may have less than N_{CB} codewords. The total required feedback bit may be determined in accordance with the following formula log 2(N_{CB})×N_{FB}. Feedback information can be piggybacked to a downlink (DL) data request packet, such as a PS_Poll packet. N_{CB} and N_{FB} may be indicated prior to feedback. The values for N_{CB} and N_{FB} may change infrequently, thus this information can be communicated less frequently than other information (e.g., N_{CB} and N_{FB} can be communicated while transmitting system information). Within the context of this disclosure, the number of feedback groups (N_{FB}), the number of candidate beamforming vectors (N_{CB}), and the number of sub-carriers (N_{SD}) may be configurable, or may vary depending on network conditions.

Access points having multiple candidate BF vectors (e.g., with a size of N_{CB}) for data packet transmission may apply different BF vectors in adjacent subcarriers. After receiving the reference packet, STAs measure the signal quality of the received reference packet for each subcarrier, and choose the sub-carrier with the highest signal quality (out of N_{CB} candidate adjacent subcarriers). The STAs feedback the index of the sub-carriers with the highest signal quality to the AP (out of N_{CB} candidate adjacent subcarriers). At the time of data packet transmission, the AP transmits the packet with applying BF vector corresponding to the sub-carriers that was feedback from the STA.

For example, entire data sub-carriers (N_{SD}) are grouped with N_{CB} consecutive subcarriers. For reference packet transmission, AP multiplies different BF vectors for different sub-carrier within a group.→(w₁˜W_{N}_{_{—}}_{CB}) STA feedbacks the sub-carrier index of the best signal quality. At the time of data packet transmission, AP transmits data packet to the STA using BF vector for whole N_{CB} consecutive sub-carriers of the group.

When spatial characteristics are similar throughout an entire channel, a single BF weight vector may be used for the entire channel bandwidth in order to achieve similar performance with less overhead. By using one codebook for different sub-carrier groups, the receiver can combine the signal quality of different sub-carriers using the same BF vector in order to improve noise immunity.

One of target applications of 802.11ah is low cost devices such as sensors, as described by Institute of Electrical and Electronics Engineers (IEEE) standard publication P802.11-11/0905r03 (2011) entitled “TGah Functional Requirements and Evaluation Methodology Rev. 3,” (hereinafter ‘IEEE P802.11’), which is incorporated herein by reference in its entirety. When relatively small number of transmission/reception antennas are used (e.g., two Tx/Rx antennas), complicated MIMO processing at the receiver may be avoided to achieve low cost and low power consumption characteristics. Short packet with large duty cycle is likely such that sounding, channel feedback, and/or antenna calibration overhead is too much. Therefore, closed-loop beamforming scheme with low complexity and low overhead may be beneficial for sensor users. If complexity and overhead level is not low enough, sensor users may use open-loop scheme at the cost of link performance. 802.11ah channel is different from that of 802.11n/ac.

As discussed herein, beamforming weight vectors may be referred to as beamforming weight matrixes and/or codewords, and may refer to any configurable transmission parameters used to effectuate beamforming. In some embodiments, the receivers may not know specific used BF vectors, as the selection of available BF vectors may come down to implementation. However at least within N_{FB} groups, same codebook with the size of N_{CB} may be used.

Beamforming techniques are implemented in many wireless access networks, including wireless fidelity (Wi-Fi) networks operating in accordance with the IEEE standard publication 802.11-2012, which is incorporated herein by reference as if reproduced in its entirety. Indeed, closed-loop beamforming schemes are defined in standard amendments IEEE 802.11n and IEEE 802.11ac specifications, both of which are also incorporated by reference herein as if reproduced in their entireties. The beamforming schemes discussed in IEEE 802.11n and IEEE 802.11ac select the BF weight matrix in accordance with CSI, which is obtained via implicit or explicit feedback. During implicit feedback, the transmitter (device A) performs channel estimation on a sounding packet transmitted by the receiver (device B) to obtain CSI information for the B→A channel, which is used to infer CSI for the A→B channel. In some instances, calibration may be required to insure that CSI for the A→B channel may be accurately inferred from the CSI information for the B→A channel.

During explicit feedback, the receiver (device B) performs channel estimation on a sounding packet transmitted by the receiver (device A) to obtain CSI information for the AB channel, and either feeds back the CSI information to the transmitter or feeds back BF weights matrix computed from the CSI to the transmitter. When returning CSI feedback, Device B may send the estimated channel information without calculating BF weight matrix. The amount of CSI may correspond to the dimensionality of the system. For instance, 4×4 40 MHz may include 16 complex elements×114 sub-carriers×quantization (16 bits IQ) for a total of about 3648 bytes. To reduce the overhead, less quantization precision, one weight matrix for multiple sub-carriers can be used. When returning non-compressed BF weights, Device B may compute the BF weight matrix and feed this matrix back to device A. The overhead of the non-compressed BF weights may be similar to (or even identical to) that of CSI feedback. When returning compressed BF weights feedback, device B may use a unitary matrix for BF weights. Alternatively, polar coordinate may be used to reduce the number of bits in accordance with Given's rotation. For instance, compressed BF weights for a 4×4 40 MHz system may include twelve angles which may total between 12 and 48 bits depending on quantization level. But, non-compressed BF may be between 128 and 256 bits per subcarrier.

IEEE 802.11ah is a planned addition to the 802.11 standard, and will be specifically designed for use in sensor networks and for smart metering. IEEE 802.11ah networks may have different channel characteristics and usage scenarios than other IEEE 802.11 standards. More specifically, 802.11ah networks may use narrower tone spacing (e.g., 31.25 kHz rather than 312.5 kHz) than other IEEE 802.11 networks, thereby causing adjacent tones to be substantially more correlated in 802.11ah networks. Additionally, 802.11ah networks may utilize a lower carrier frequency (e.g., 900 MHz rather than the 2.4-5 GHz) than other 802.11 networks, which may result in 802.11ah network using narrower antenna spacing to accommodate longer carrier wavelengths. Further, IEEE 802.11ah networks may utilize narrower channels (e.g., 1-16 MHz channel bandwidths rather than 20 MHz channel bandwidths) than other 802.11 networks, thereby causing the channel to be more spatially correlated (particularly when the 802.11ah network is operating in 1 MHz or 2 MHz mode.

Further, sensor devices tend to have different operating characteristics than other wireless devices. For instance, sensors tend to be installed in static locations, and therefore exhibit near static channel characteristics. Sensors also tend to be low cost devices that are distributed in wider coverage areas and utilize smaller packet sizes. As a result, single stream beamforming that can extend coverage will be adequate for most sensor implementations. To summarize: IEEE 802.11ah channel conditions may be closely correlated in the spatial domain for entire channel bandwidth; IEEE 802.11ah channel conditions may exhibit slow channel variation in the time domain; and IEEE 802.11ah channel response for multiple adjacent sub-carriers may often fall within coherent bandwidth.

The conventional implicit and explicit feedback schemes relied upon by IEEE 802.11n and IEEE 802.11ac may be ill-suited for sensors for a variety of reasons. For instance, sensors may typically be low cost devices that lack the capability of performing complex weight matrix calculation. Additionally, frequent sounding packet transmission, periodic message exchange for calibration, and/or complex baseband operations (e.g. beamforming weight compression, etc.) may consume too much power of battery operated sensors. Moreover, packet sizes for sensors may be small such that additional feedback overhead associated with beamforming (e.g., CSI, beamforming weights, etc.) significantly deteriorate spectrum efficiency.

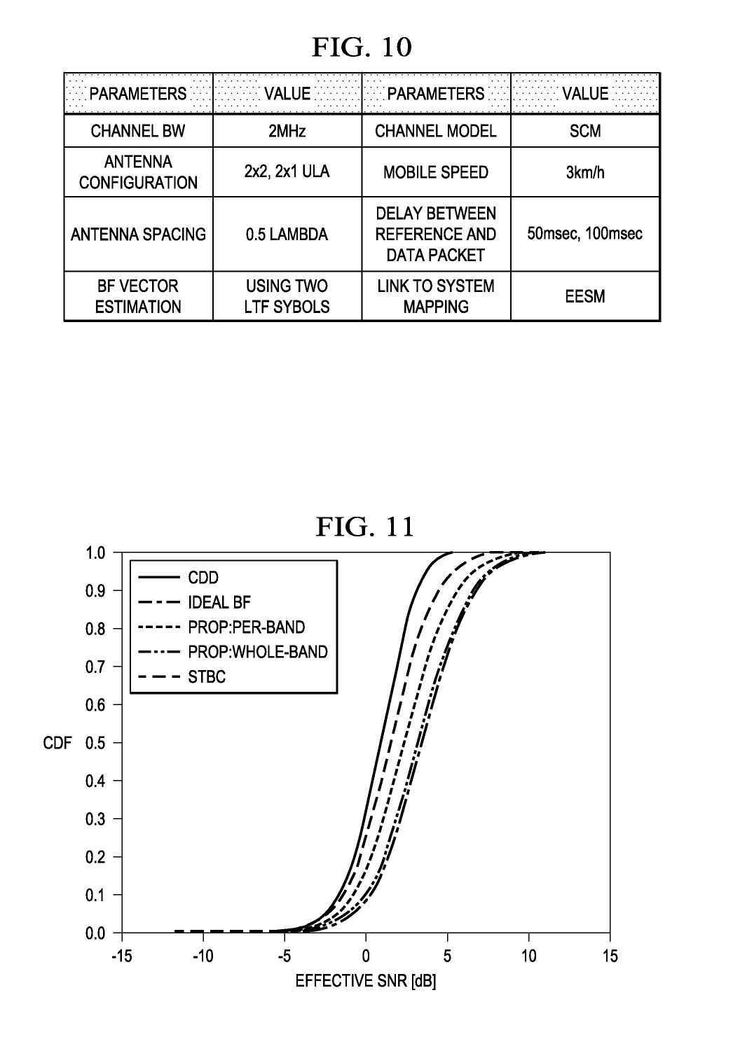

FIG. 10 illustrates a table of assumptions that may be used in simulations. The following schemes may be considered: CDD with 2 sample delay; STBC; Ideal BF (channel measurement at Ref. pkt); Proposed scheme with codebook size of 4; Use of LTE codebook: {(1,1), (1,−1), (1,j), (1,−j)}/sqrt(2); two options: per-band feedback, whole-band feedback.

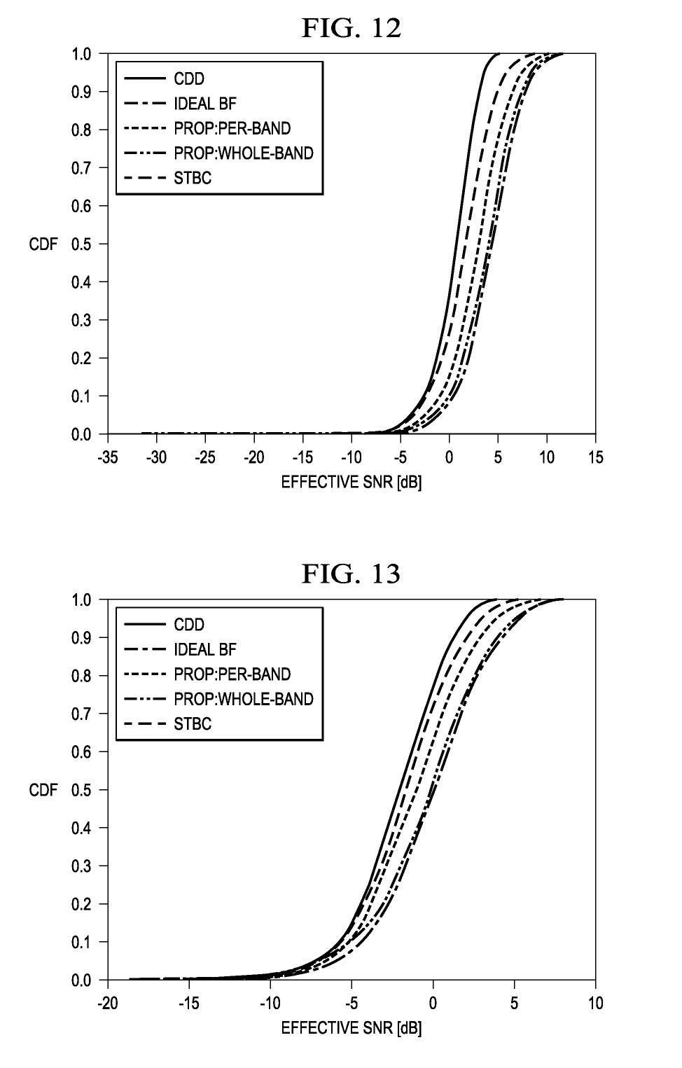

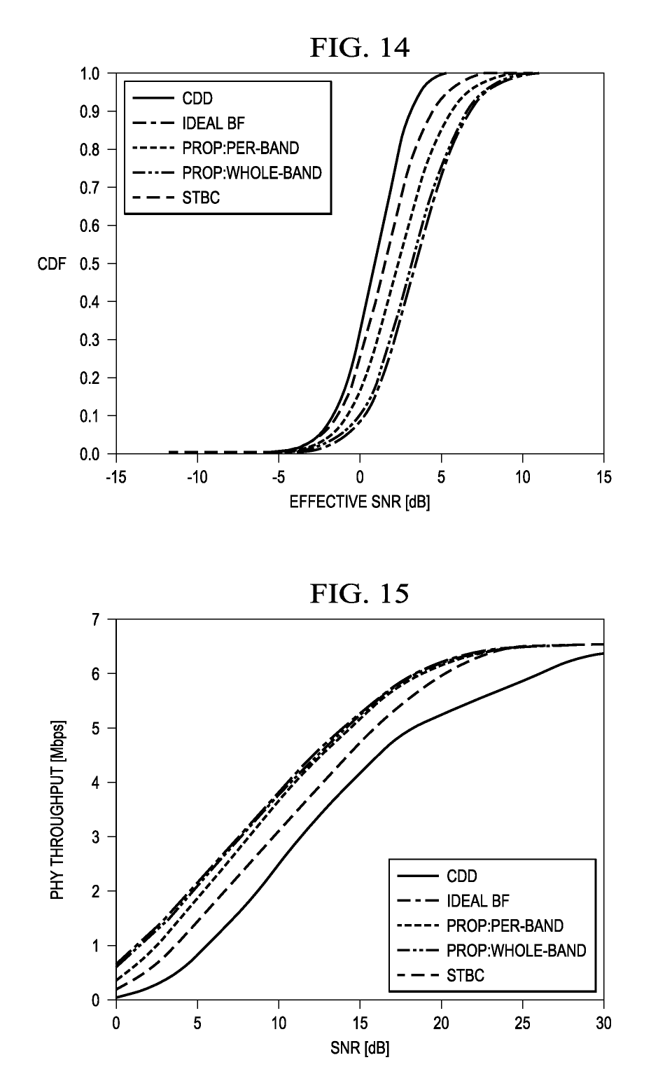

FIGS. 11-15 illustrate graphs of simulations results obtained when using various aspects of this disclosure. More specifically, FIG. 11 illustrates simulation results of CDF of effective SINR: SCM Umi, 2×2, 50 msec delay, SNR=0 dB; FIG. 12 illustrates simulation results of CDF of effective SINR: SCM Sma, 2×2, 50 msec delay, SNR=0 dB; FIG. 13 illustrates simulation results of CDF of effective SINR: SCM Sma, 2×1, 50 msec delay, SNR=0 dB; FIG. 14 illustrates simulation results of CDF of effective SINR: SCM Umi, 2×2, 100 msec delay, SNR=0 dB; and FIG. 15 illustrates simulation results of PHY Throughput: SCM Umi, 2×2, 50 msec delay.

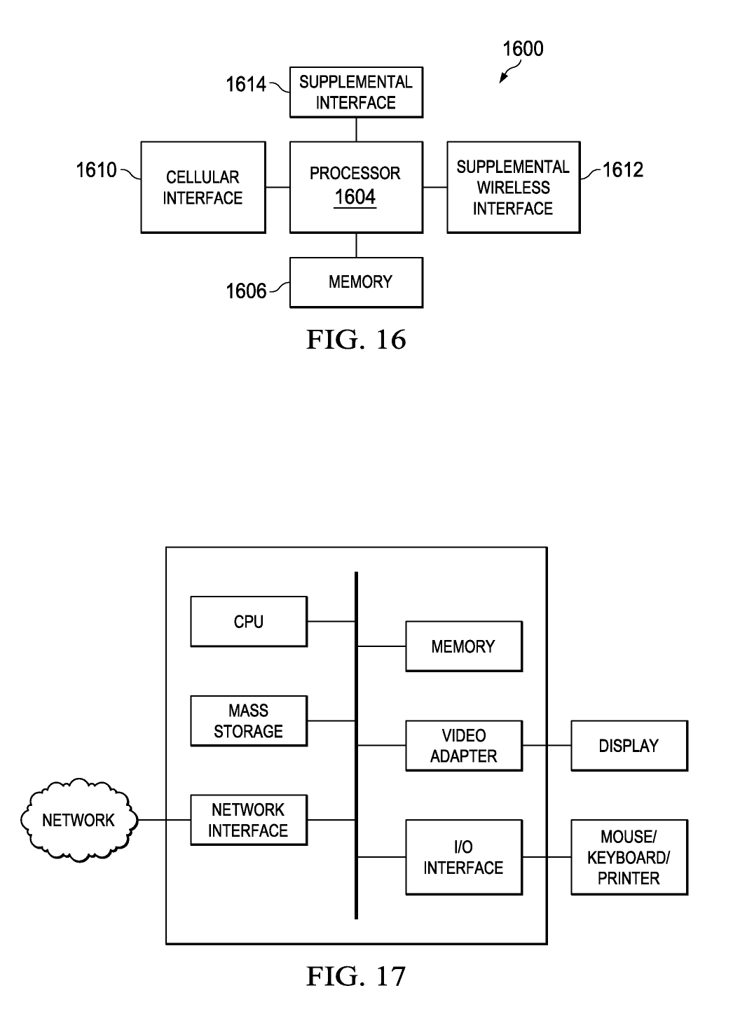

FIG. 16 illustrates a block diagram of an embodiment of a communications device 1600, which may be equivalent to one or more devices (e.g., UEs, eNBs, etc.) discussed above. The communications device 1600 may include a processor 1604, a memory 1606, a cellular interface 1610, a supplemental wireless interface 1612, and a supplemental interface 1614, which may (or may not) be arranged as shown in FIG. 16. The processor 1604 may be any component capable of performing computations and/or other processing related tasks, and the memory 1606 may be any component capable of storing programming and/or instructions for the processor 1604. The cellular interface 1610 may be any component or collection of components that allows the communications device 1600 to communicate using a cellular signal, and may be used to receive and/or transmit information over a cellular connection of a cellular network. The supplemental wireless interface 1612 may be any component or collection of components that allows the communications device 1600 to communicate via a non-cellular wireless protocol, such as a Wi-Fi or Bluetooth protocol, or a control protocol. The supplemental interface 1614 may be component or collection of components that allows the communications device 1600 to communicate via a supplemental protocol, including wire-line protocols.

FIG. 17 is a block diagram of a processing system that may be used for implementing the devices and methods disclosed herein. Specific devices may utilize all of the components shown, or only a subset of the components, and levels of integration may vary from device to device. Furthermore, a device may contain multiple instances of a component, such as multiple processing units, processors, memories, transmitters, receivers, etc. The processing system may comprise a processing unit equipped with one or more input/output devices, such as a speaker, microphone, mouse, touchscreen, keypad, keyboard, printer, display, and the like. The processing unit may include a central processing unit (CPU), memory, a mass storage device, a video adapter, and an I/O interface connected to a bus.

The bus may be one or more of any type of several bus architectures including a memory bus or memory controller, a peripheral bus, video bus, or the like. The CPU may comprise any type of electronic data processor. The memory may comprise any type of system memory such as static random access memory (SRAM), dynamic random access memory (DRAM), synchronous DRAM (SDRAM), read-only memory (ROM), a combination thereof, or the like. In an embodiment, the memory may include ROM for use at boot-up, and DRAM for program and data storage for use while executing programs.

The mass storage device may comprise any type of storage device configured to store data, programs, and other information and to make the data, programs, and other information accessible via the bus. The mass storage device may comprise, for example, one or more of a solid state drive, hard disk drive, a magnetic disk drive, an optical disk drive, or the like.

The video adapter and the I/O interface provide interfaces to couple external input and output devices to the processing unit. As illustrated, examples of input and output devices include the display coupled to the video adapter and the mouse/keyboard/printer coupled to the I/O interface. Other devices may be coupled to the processing unit, and additional or fewer interface cards may be utilized. For example, a serial interface card (not shown) may be used to provide a serial interface for a printer.

The processing unit also includes one or more network interfaces, which may comprise wired links, such as an Ethernet cable or the like, and/or wireless links to access nodes or different networks. The network interface allows the processing unit to communicate with remote units via the networks. For example, the network interface may provide wireless communication via one or more transmitters/transmit antennas and one or more receivers/receive antennas. In an embodiment, the processing unit is coupled to a local-area network or a wide-area network for data processing and communications with remote devices, such as other processing units, the Internet, remote storage facilities, or the like.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for selecting beamforming parameters, the method comprising:
applying a plurality of beamforming weight vectors to a reference packet; and
communicating the reference packet over a plurality of sub-carriers, wherein the plurality of beamforming weight vectors are applied to the reference packet such that different beamforming weight vectors are applied to different sub-carriers.

2. The method of claim 1, further comprising:
receiving an index from a station (STA), the index identifying a sub-carrier in the plurality of sub-carriers having a highest signal quality;
identifying which beamforming weight vector in the plurality of beamforming weight vectors was applied to the identified sub-carrier; and
transmitting information to the STA over the plurality of sub-carriers in accordance with the identified beamforming weight vector.

3. The method of claim 1, wherein the plurality of sub-carriers includes two or more groups of consecutive sub-carriers.

4. The method of claim 3, wherein each of the plurality of beamforming weight vectors belong to a single codebook, and wherein the single codebook is applied to each of the two or more groups of consecutive sub-carriers such that each beamforming weight vector in the single codebook is applied to each of the two or more groups of consecutive sub-carriers.

5. The method of claim 4, further comprising receiving an index from a station (STA), the index identifying a highest quality sub-carrier in each group of consecutive sub-carriers.

6. The method of claim 4, further comprising receiving an index from a station (STA), the index identifying a beamforming weight vector in the single codebook that provides a highest average signal quality across the two or more groups of consecutive sub-carriers.

7. The method of claim 3, wherein the plurality of beamforming weight vectors includes at least a first set of beamforming weight vectors belonging to a first codebook and a second set of beamforming weight vectors belonging to a second codebook,
wherein the first codebook is applied to a first group of consecutive sub-carriers in the two or more groups of consecutive sub-carriers, and
wherein the second codebook is applied to a second group of consecutive sub-carriers in the two or more groups of consecutive sub-carriers.

8. The method of claim 7, wherein the first set of beamforming weight vectors are applied to the first group of consecutive sub-carriers without being applied to the second group of consecutive sub-carriers, and
wherein the second set of beamforming weight vectors are applied to the second group of consecutive sub-carriers without being applied to the first group of consecutive sub-carriers.

9. The method of claim 1 further comprising:
communicating a second reference packet over the plurality of sub-carriers, wherein a second plurality of beamforming weight vectors are applied to the second reference packet such that different beamforming weight vectors are applied to different sub-carriers.

10. The method of claim 9, wherein the second plurality of beamforming weight vectors are different than the first plurality of beamforming weight vectors, and wherein the second reference packet is communicated after the reference packet.

11. The method of claim 1, wherein the reference packet is a beacon packet communicated in accordance with Institute of Electrical and Electronics Engineers (IEEE) 801.11ah.

12. The method of claim 1, wherein the reference packet is a Null Data Packet (NDP) including a preamble, where the NDP does not deliver any data to a station (STA) receiving the reference packet.

13. A transmitting device comprising:
a processor; and
a computer readable storage medium storing programming for execution by the processor, the programming including instructions to:
apply a plurality of beamforming weight vectors to a reference packet; and
communicate the reference packet over a plurality of sub-carriers, wherein the instructions to apply the plurality of beamforming weight vectors to the reference packet include instructions to apply the plurality of beamforming weight vectors such that different beamforming weight vectors are applied to different sub-carriers.

14. A method for selecting beamforming weights, the method comprising:
receiving, by a station (STA), a reference packet from a transmitter, wherein the reference packet is received over a plurality of sub-carriers, and wherein the transmitter applies different beamforming weight vectors to different ones of the plurality of sub-carriers when transmitting the reference packet;
identifying a sub-carrier in the plurality of sub-carriers having a highest signal quality; and
transmitting an index to the transmitter, the index identifying the sub-carrier having the highest signal quality.

15. The method of claim 14, wherein the reference packet is a beacon packet communicated in accordance with Institute of Electrical and Electronics Engineers (IEEE) 801.11ah.

16. The method of claim 14 further comprising:
receiving a data packet from the transmitter after transmitting the index to the transmitter, the data packet being transmitted over each of the plurality of sub-carriers in accordance with a beamforming weight vector associated with the sub-carrier having the highest signal quality as identified by the index.

17. The method of claim 14, wherein the plurality of sub-carriers includes two or more groups of consecutive sub-carriers.

18. The method of claim 17, further comprising:
identifying a highest quality sub-carrier in each of the two or more groups of consecutive sub-carriers; and
transmitting an index to the transmitter, the index indicating the highest quality sub-carrier in each of the two or more groups of consecutive sub-carriers.

19. The method of claim 17, further comprising:
identifying a beamforming vector that achieves a highest average signal quality; and
transmitting an index to the transmitter, the index indicating the beamforming vector that achieves a highest average signal quality.

20. A receiving device comprising:
a processor; and
a computer readable storage medium storing programming for execution by the processor, the programming including instructions to:
receive a reference packet from a transmitter, wherein the reference packet is received over a plurality of sub-carriers, and wherein the transmitter applies different beamforming weight vectors to different ones of the plurality of sub-carriers when transmitting the reference packet;
identify a sub-carrier in the plurality of sub-carriers having a highest signal quality; and
transmit an index to the transmitter, the index identifying the sub-carrier having the highest signal quality.
